(19) United States
(12) Patent Application Publication
(10) Pub. No.: US 2026/0348773 A1
(43) Pub. Date: Nov. 5, 2026

(54) TEMPERATURE SENSOR ASSEMBLY FOR SENSOR CALIBRATION

(71) Applicant: Rosemount Inc., Shakopee, MN (US)

(72) Inventors: Samuel Victor Haarala, Chaska, MN (US); Kenneth M. Oatman, Shakopee, MN (US); John Reuvers, Minneapolis, MN (US)

(21) Appl. No.: 19/637,626

(22) Filed: Apr. 2, 2026

Related U.S. Application Data
(60) Provisional application No. 63/798,157, filed on May 1, 2025.

(51) Int. Cl. G01K 15/00; G01K 1/14

(52) U.S. Cl. CPC G01K 15/005; G01K 1/146

(57) ABSTRACT

A temperature sensor assembly includes a temperature sensor including sensor leads coupled to a terminal block housed in a connection head, an elongate sensor adapter removably coupled to the connection head and configured to slidably carry and be slidably removable from around the temperature sensor, and a spring configured to be compression loaded between a portion of the temperature sensor and a constraining member. The spring is configured to urge the temperature sensor in a direction away from the connection head.

### CROSS-REFERENCE TO RELATED APPLICATION

The present application is based on and claims the benefit of U.S. provisional patent application Serial No. 63/798,157, filed May 1, 2025, the content of which is hereby incorporated by reference in its entirety.

### BACKGROUND

Temperature sensor calibration and/or verification are common in industrial processes to ensure that temperature sensors are accurate and have not drifted out of the expected range of temperature readings. To perform a calibration check on temperature sensors, liquid calibration baths or drywell calibrators may be used. Exemplary drywell calibrators include Fluke branded single block drywell calibrator model number 9103-DW-156 owned and manufactured by Fluke Corporation and Fluke branded handheld drywell calibrator model number 9100S-C-156 owned and manufactured by Fluke Corporation. Proper immersion of the sensor is important for accurate measurements during calibration to minimize ambient effects. This can be challenging with short sensors.

### SUMMARY

A temperature sensor assembly includes a temperature sensor including sensor leads coupled to a terminal block housed in a connection head and an elongate sensor adapter removably coupled to the connection head and configured to slidably carry and be slidably removable from the temperature sensor. The temperature sensor assembly further includes a spring configured to be compression loaded between a portion of the temperature sensor and a constraining member. The spring is configured to urge the temperature sensor in a direction away from the connection head.

A temperature sensor assembly includes a temperature sensor having sensor leads coupled to a terminal block housed in a connection head, an elongate sensor adapter configured to slidably carry and be slidably removable from around the temperature sensor, and a connection head adapter coupled to the connection head that is configured to removably connect the elongate sensor adapter to the connection head and includes a constraining member. The temperature sensor assembly further includes a spring configured to be compression loaded between a portion of the temperature sensor and the constraining member located in the connection head adapter. The spring is configured to urge the temperature sensor in a direction away from the connection head.

A temperature sensor assembly includes a temperature sensor having sensor leads that are coupled to a terminal block housed in a connection head, an elongate sensor adapter removably coupled to the connection head and configured to slidably carry and be slidably removable from around the temperature sensor, and a spring that is compression loaded between a portion of the temperature sensor and a constraining member. The elongate sensor adapter is configured to be disconnected from the connection head and from around the temperature sensor while the spring remains compression loaded between the portion of the temperature sensor and the constraining member to expose a length of the temperature sensor for calibration. The elongate sensor adapter is configured to be reconnected to the connection head by sliding the elongate sensor adapter back over the temperature sensor.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 illustrates a perspective view of an exemplary system that uses a temperature sensor assembly.

FIG. 2 illustrates an exemplary temperature sensor installed in a spring-loaded adapter with a fixed retention ring and a spring.

FIG. 3 illustrates an exemplary temperature sensor for use in temperature measurement of an industrial process in accordance with an embodiment.

FIG. 4 illustrates a perspective view of a temperature sensor assembly coupled to a process pipe according to an embodiment.

FIG. 5 illustrates an end view of the temperature sensor assembly of FIG. 4 with components used for coupling the temperature sensor assembly to a process pipe removed.

FIG. 6 illustrates a section view of the temperature sensor assembly of FIG. 4 taken through the section line indicated in FIG. 5.

FIG. 7 illustrates the section view of the temperature sensor assembly in FIG. 6 but with an elongate sensor adapter removed for temperature sensor calibration.

FIG. 8a illustrates a section view of a portion of a temperature sensor assembly according to another embodiment.

FIG. 8b illustrates the section view of the portion of the temperature sensor assembly in FIG. 8a but with an elongate sensor adapter removed for temperature sensor calibration.

FIG. 9a illustrates a section view of a temperature sensor assembly according to yet another embodiment.

FIG. 9b illustrates the section view of the temperature sensor assembly in FIG. 9a but with an elongate sensor adapter removed for temperature sensor calibration.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

Drywell temperature sensor calibrators have a minimum sensor immersion length that is typically required for the sensor to be immersed to ensure that the surrounding temperature of the calibrator is consistent and uniform. The less a sensor is immersed into the drywell, the greater the set point of the drywell may be different from what the actual sensor is experiencing and could lead to erroneous readings. In addition, if the sensor is not immersed sufficiently into the drywell, the calibration will not be accurate. This can be particularly problematic for sensors that have a short length. Further, liquid calibration baths also require sufficient immersion length. Therefore, the following embodiments are applicable to any well or bath required for sensor calibration.

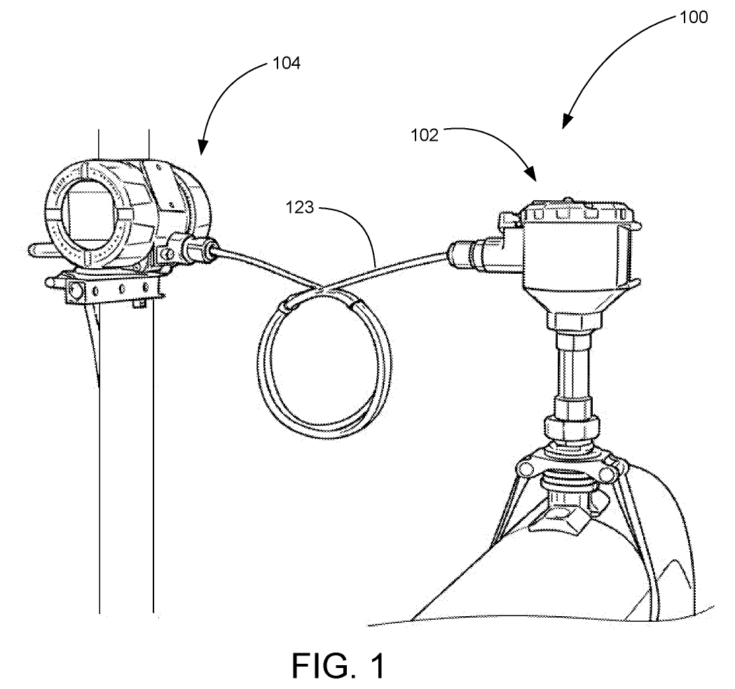

FIG. 1 illustrates an exemplary system 100 and includes an exemplary temperature sensor assembly 102 coupled to a temperature transmitter 104 that may be mounted remotely or directly. In the FIG. 1 example, temperature transmitter 104 is remotely located from and coupled to temperature sensor assembly 102 by a cable 123. In exemplary system 100, pipe surface sensors and algorithms are used to calculate internal pipe temperature without needing a traditional thermowell or cutting into process pipes. However, it should be understood that described embodiments may be used in other exemplary systems including intrusive temperature measurement systems that include a thermowell.

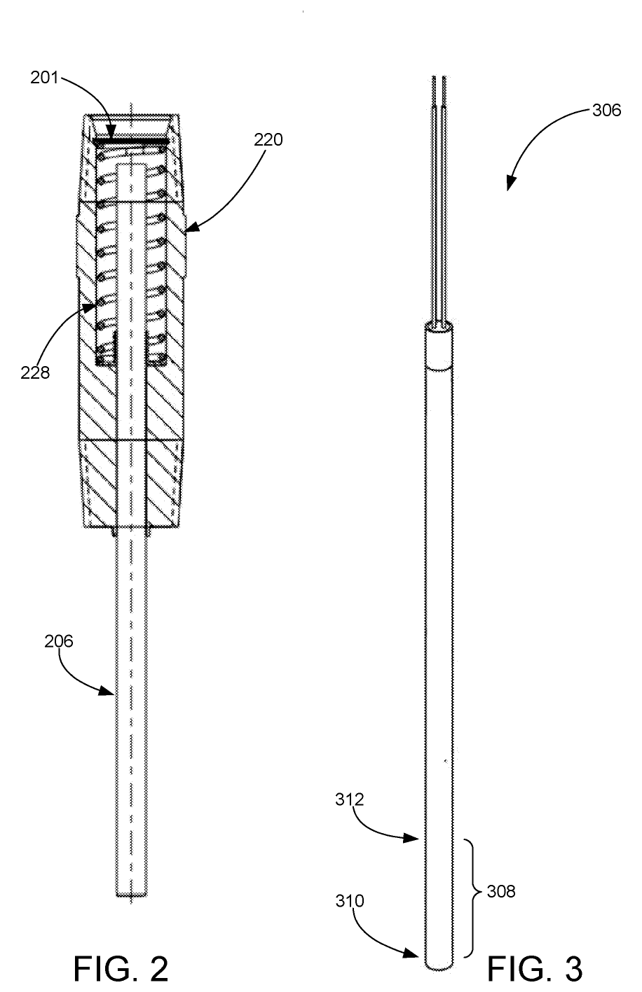

Temperature sensor assembly 102 and other temperature sensor assemblies in other types of systems include a temperature sensor that may come installed into a spring-loaded adapter with a fixed retention ring. For example, FIG. 2 illustrates an exemplary temperature sensor 206 installed into a spring-loaded adapter 220 with a fixed retention ring 201 and a spring 228. Retention or retaining ring 201 is pressed into an internal groove in adapter 220 to keep spring 228 and sensor 206 fixed in place. While the FIG. 2 configuration may ensure that temperature sensor 206 cannot come loose from spring-loaded adapter 220, and that temperature sensor 206 can achieve good spring contact with a thermowell or pipe surface, it is difficult to remove spring-loaded adapter 220 from retention or retaining ring 201 and either spring-loaded adapter 220 or retention ring 201 may be damaged if removal is attempted. Therefore, spring-loaded adapter 220 makes it very difficult to to perform a calibration on sensor 206 with very little of the length of sensor 206 exposed for calibration. While a longer sensor could be employed to ensure that there is enough length to be properly immersed into a drywell or liquid bath for accurate calibration, in many instances, shorter length sensors installed in spring-loaded adapters need to be used, which makes calibration even more difficult.

In one example, FIG. 3 illustrates a temperature sensor probe 306 that utilizes two internal thermocouple junctions (shown generally at 310 and 312 but hidden from view) that are spaced apart from each other by a relatively short distance 308 relative to the total height of the sensor body. For example, distance 308 may be approximately one inch. This spaced distance 308 needs to be considered when performing a calibration and to ensure that both first thermocouple junction 310 and second thermocouple junction 312 are within the stated minimum immersion depth of the drywell or calibration bath. When paired with spring loaded adapter in FIG. 2, the likelihood that a proper calibration occurs will drop even more as the sensor may be put into a drywell or calibration bath with the adapter still installed, which limits its immersion depth.

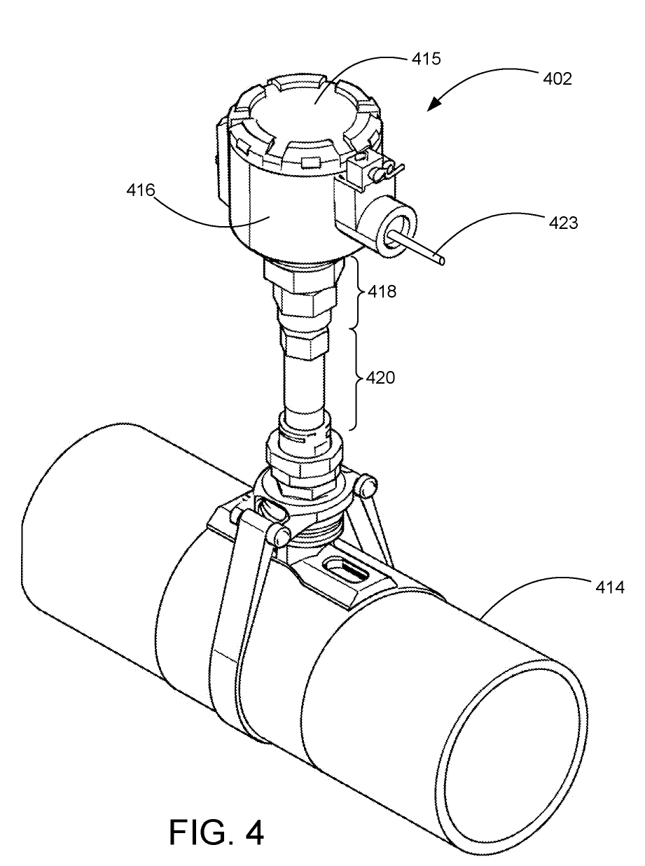

FIG. 4 illustrates a temperature sensory assembly 402 mounted to a process pipe 414 according to an embodiment. Temperature sensory assembly 402 includes a connection head 416 that houses a terminal block (not illustrated in FIG. 4) and a cover 415 that encloses connection head 416 and allows for access to the terminal block located inside connection head 416. Temperature sensory assembly 402 further includes a connection head adapter 418 and an elongate sensor adapter 420.

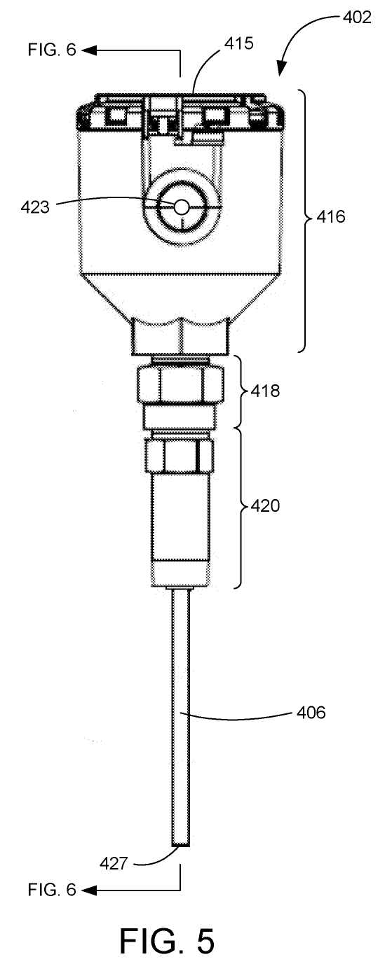

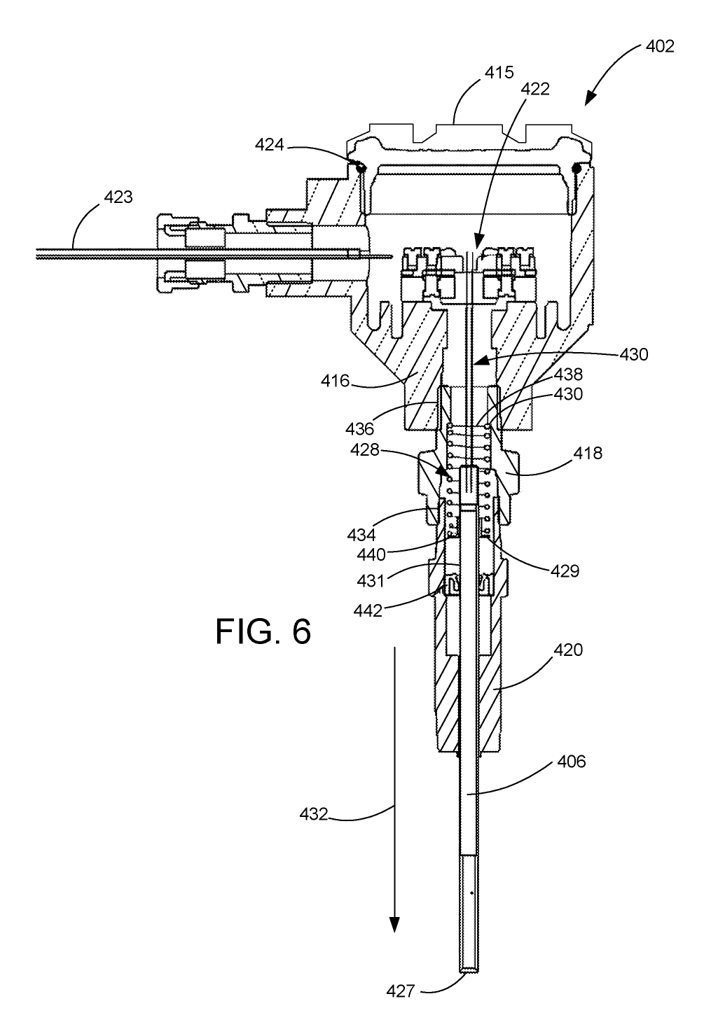

FIG. 5 illustrates an end view of temperature sensor assembly 402 of FIG. 4 with components used for coupling the temperature sensor assembly 402 to a process pipe removed. FIG. 6 illustrates a section view of temperature sensor assembly 402 taken through the section line indicated in FIG. 5. The configuration illustrated in FIGS. 4 - 6 provides an easier disassembly of elongate sensor adapter 420 from temperature sensor 406. This allows for shorter or other unique temperature sensors, like temperature sensor 406, to be more fully immersed in drywells or baths for calibration/verification. As discussed, calibration is required to ensure that the temperature measurement is accurate, and drywells or baths require sensors to be installed to a certain depth for a reliable reference measurement. For example, existing spring-loaded sensor adapters, such as spring-loaded 220 in FIG. 2, utilize a fixed retention ring. In contrast, elongate sensor adapter 420 illustrated in FIGS. 4-6 can be disassembled easily with, for example, a wrench while still providing the necessary spring retention of the assembly to ensure contact is maintained between the sensor tip or interface 427 and a measurement interface, such as a pipe wall surface or a blind thermowell bottom, when installed.

As illustrated in FIG. 6, temperature sensor assembly 402 includes a temperature sensor 406 having sensor leads 430 that are coupled to terminal block 422 housed in connection head 416. Terminal block 422 provides a point inside connection head 416 where sensor leads 230 may connect to a cable 423 that may couple to a temperature transmitter, such as temperature transmitter 104 in FIG. 1. Cover 415 encloses connection head 416 and allows for access to terminal block 422. O-ring 424 provides ingress protection (IP) between cover 415 and connection head 416.

Temperature sensor assembly 402 includes elongate sensor adapter 420 removably coupled to connection head 416 and configured to slidably carry and be slidably removable from around temperature sensor 406. Temperature assembly 402 further includes a spring 428 having first and second ends 438 and 440 and configured to be compression loaded between a portion of temperature sensor 406 and a constraining member 430. In particular, the portion of temperature sensor 406 that provides compression to spring 428 is a spring seat 429 having a resting surface that is crimped to and protrudes from a sensor wall or capsule 431 of temperature sensor 406 to receive a force that spring 428 exerts in a first direction. Constraining member 430 provides compression to spring 428 and receives a force that spring 428 exerts in a second opposing direction. As illustrated, first end 438 of spring 428 is configured to abut constraining member 430 and second end 440 of spring 428 is configured to abut spring seat 429 of temperature sensor 406. The compressive force of spring 429 urges temperature sensor 406 in a direction 432 away from connection head 416 to thereby maintain contact between sensor tip 427 and a measurement interface for improved measurement performance.

To solve the problem of calibrating short sensors and other unique sensor designs, elongate sensor adapter 420, which houses, contains, slidably carries and is slidably removable from around temperature sensor 406, is removably coupled to connection head 416 by way of a connection head adapter 418. For example, elongate sensor adapter 420 is removably coupled to connection head adapter 418 by, for example, a threaded joint 434, and in turn, connection head adapter 418 may be removably coupled to connection head 416 by, for example, a threaded joint 436. In FIGS. 5 - 6, constraining member 430 comprises a shoulder internally located in connection head adapter 418 to receive a force that spring 429 exerts in the second opposing direction. Therefore, connection head adapter 418 acts as both a spring stop on first end 438 of spring 428 to ensure spring force remains in temperature sensor assembly 402 when installed, while also allowing elongate sensor adapter 420 to be much easier to remove from around the temperature sensor 406 for calibration/verification of temperature sensor 406.

Elongate sensor adapter 420 further includes an internally located wiper seal 442 that provides a seal around temperature sensor 406 that prevents contaminants from entering connection head 416. In addition, wiper seal 442 of elongate sensor adapter 420 is configured to wipe away debris from temperature sensor 406 when elongate sensor adapter 420 is removed from temperature sensor 406.

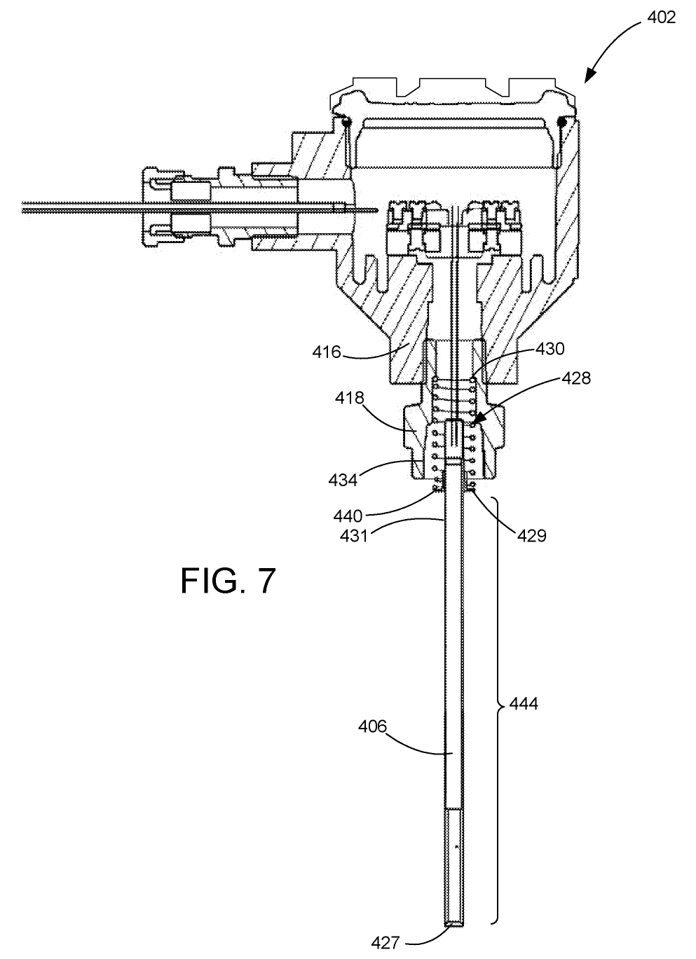

FIG. 7 illustrates the section view in FIG. 6 of temperature sensor assembly 402 but with elongate sensor adapter 420 removed for temperature sensor calibration. Elongate sensor adapter 420 is disconnected from connection head adapter 418 and therefore from connection head 416 by, for example, unthreading elongate sensor adapter 420 from threaded joint 434. When elongate sensor adapter 420 is disconnected or removed, spring 428 remains contained between spring seat 429 and constraining member or shoulder 430. In addition, when elongate sensor adapter 420 is removed, a length 444 of temperature sensor 406 is exposed for calibration.

Exposed length 444 of temperature sensor 406 is then calibrated using a calibration system, such as a bath or drywell calibrator like those owned and manufactured by Fluke Corporation. After calibration, elongated sensor adapter 420 is reconnected to connection head adapter 418 and therefore connection head 416 by sliding elongate sensor adapter 420 over temperature sensor 406 and threading threaded joint 434.

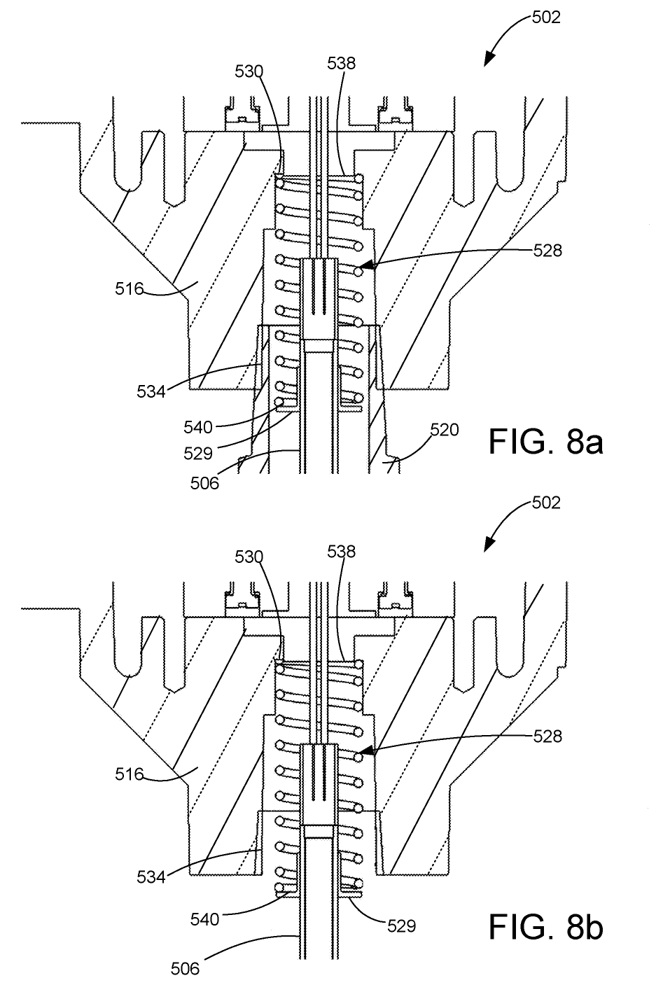

FIG. 8a illustrates a section view of a portion of a temperature sensor assembly 502 according to another embodiment. Similar to temperature sensor assembly 402, temperature sensor assembly 502 includes a spring 528 having first and second ends 538 and 540 and is configured to be compression loaded between spring seat 529 and a constraining member 530. In this alternative configuration, however, a connection head 516 of temperature sensor assembly 502 is modified to incorporate constraining member 530 for spring 528 to sit on, which eliminates the need for an intermediary machined piece, such as connection head adapter 418. As illustrated in FIG. 8a, an elongate sensor adapter 520, which houses, contains, slidably carries and is slidably removable from temperature sensor 506, is directly removably coupled to connection head 516. For example, elongate sensor adapter 520 is removably coupled to connection head 516 by, for example, a threaded joint 534. Constraining member 530 of connection head 516 comprises a shoulder internally located inside connection head 516 to receive a force that spring 529 exerts in the opposing second direction. Therefore, connection head 516 acts as both a spring stop on a first end 538 of spring 528 to ensure spring force remains in temperature sensor assembly 502 when installed, while also allowing elongate sensor adapter 520 to be easy to remove from around temperature sensor 526 for calibration/verification.

FIG. 8b illustrates the section view of the portion of the temperature sensor assembly in FIG. 8a but with an elongate sensor adapter 520 removed for temperature sensor 506 calibration. Elongate sensor adapter 520 is disconnected from connection head 516 by, for example, unthreading elongate sensor adapter 520 from connection head 516. When elongate sensor adapter 520 is disconnected or removed, spring 528 remains contained between spring seat 529 and constraining member or shoulder 530. In addition, when elongate sensor adapter 520 is removed, a length of temperature sensor 506 is exposed for calibration. The exposed length of temperature sensor 506 is then calibrated using a calibration system, such as a bath or drywell calibrator like those owned and manufactured by Fluke Corporation. After calibration, elongated sensor adapter 520 is reconnected to connection head 516 and by sliding elongate sensor adapter 520 over temperature sensor 506 and threading adapter 520 with connection head 516.

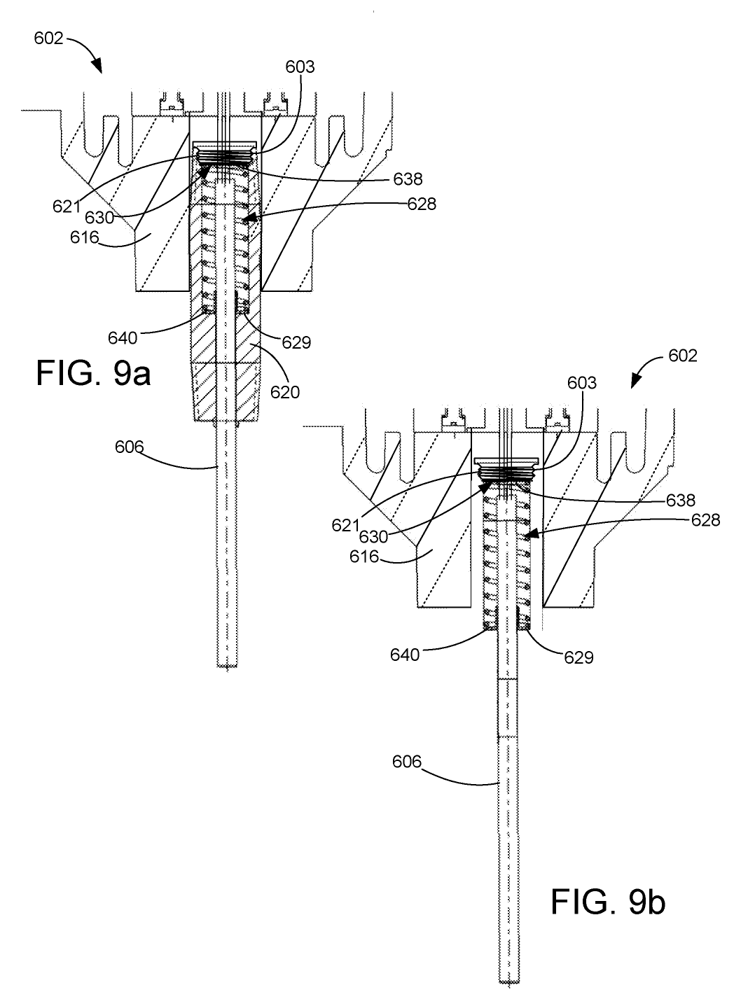

FIG. 9a illustrates a section view of a temperature sensor assembly 602 according to yet another embodiment. Similar to temperature sensor assemblies 402 and 502, temperature sensor assembly 602 includes a spring 628 having first and second ends 638 and 640 and is configured to be compression loaded between spring seat 629 and a constraining member 630. In this alternative configuration, however, constraining member 630 comprises a retention ring configured to retain a first end 638 of spring 628 that is opposite a second end 640 of spring 628 that engages with spring seat 629 to receive a force that spring 628 exerts in the second opposing direction. Elongate sensor adapter 620 is removably coupled to retention ring 630 by, for example, a threaded joint. As illustrated in FIG. 9a, threaded retention or retaining ring 630 includes male threads 603 that mate with female threads 621 of elongate sensor adapter 620. The FIG. 9a configuration ensures that temperature sensor 606 cannot come loose from adapter 620, and temperature sensor 606 can achieve good spring contact with a thermowell or pipe surface. In addition, elongate sensor adapter 620 is also easy to remove from threaded retention or retaining ring 630 to allow access to a length of temperature sensor 606 to perform a calibration as well as access to short sensors for doing accuracy checks. FIG. 9b illustrates the section view of the temperature sensor assembly in FIG. 9a but with elongate sensor adapter 620 removed for temperature sensor 629 calibration. Elongate sensor adapter 620 is disconnected from retention ring 630 by, for example, unthreading. When elongate sensor adapter 620 is disconnected or removed, spring 628 remains contained between spring seat 629 and retention ring 630. In addition, when elongate sensor adapter 620 is removed, a length of temperature sensor 606 is exposed for calibration. The exposed length of temperature sensor 606 is then calibrated using a calibration system, such as a bath or drywell calibrator. After calibration, elongated sensor adapter 620 is reconnected by sliding elongate sensor adapter 620 over temperature sensor 606 and threading adapter 620 with retention ring 630.

Although the present invention has been described with reference to preferred embodiments, workers skilled in the art will recognize that changes may be made in form and detail without departing from the spirit and scope of the invention. Any appropriate couple technique can be used including, for example, a threaded connection.

What is claimed is:

1. A temperature sensor assembly comprising:
a temperature sensor including sensor leads coupled to a terminal block housed in a connection head;
an elongate sensor adapter removably coupled to the connection head and configured to slidably carry and be slidably removable from around the temperature sensor; and
a spring configured to be compression loaded between a portion of the temperature sensor and a constraining member; and
wherein the spring is configured to urge the temperature sensor in a direction away from the connection head.

2. The temperature sensor assembly of claim 1, wherein the portion of the temperature sensor comprises a spring seat having a resting surface that protrudes from a sensor wall of the temperature sensor to receive a force that the spring exerts in a first direction.

3. The temperature sensor assembly of claim 2, further comprising a connection head adapter coupled to the connection head.

4. The temperature sensor assembly of claim 3, wherein the constraining member comprises a shoulder internally located in the connection head adapter to receive a force that the spring exerts in a second opposing direction.

5. The temperature sensor assembly of claim 4, wherein the elongate sensor adapter is removably coupled to the connection head adapter by a threaded joint and therefore slidably removable from around the temperature sensor to expose a length of the temperature sensor for calibration.

6. The temperature sensor assembly of claim 2, wherein the constraining member comprises a shoulder internally located in the connection head to receive a force that the spring exerts in a second opposing direction.

7. The temperature sensor assembly of claim 6, wherein the elongate sensor adapter is removably coupled to the connection head by a threaded joint and therefore slidably removable from around the temperature sensor to expose a length of the temperature sensor for calibration.

8. The temperature sensor assembly of claim 2, wherein the constraining member comprises a retention ring configured to retain a first end of the spring opposite a second end of the spring that engages with the spring seat.

9. The temperature sensor assembly of claim 8, wherein the elongate sensor adapter is removably coupled to the retention ring by a threaded joint and therefore slidably removable from around the temperature sensor to expose a length of the temperature sensor for calibration.

10. A temperature sensor assembly comprising:
a temperature sensor including sensor leads coupled to a terminal block housed in a connection head;
an elongate sensor adapter configured to slidably carry and be slidably removable from around the temperature sensor;
a connection head adapter coupled to the connection head and configured to removably connect the elongate sensor adapter to the connection head and includes a constraining member; and
a spring configured to be compression loaded between a portion of the temperature sensor and the constraining member located in the connection head adapter; and
wherein the spring is configured to urge the temperature sensor in a direction away from the connection head.

11. The temperature sensor assembly of claim 10, wherein the portion of the temperature sensor comprises a spring seat having a resting surface that protrudes from a sensor wall of the temperature sensor to receive a force that the spring exerts in a first direction.

12. The temperature sensor assembly of claim 11, wherein the constraining member comprises a shoulder internally located in the connection head adapter to receive a force that the spring exerts in a second opposing direction.

13. The temperature sensor assembly of claim 10, wherein the elongate sensor adapter is removably coupled to the connection head adapter by a threaded joint and therefore slidably removable from around the temperature sensor to expose a length of the temperature sensor for calibration.

14. A temperature sensor assembly comprising:
a temperature sensor having sensor leads that are coupled to a terminal block housed in a connection head;
an elongate sensor adapter removably coupled to the connection head and configured to slidably carry and be slidably removable from around the temperature sensor; and
a spring that is compression loaded between a portion of the temperature sensor and a constraining member;
wherein the elongate sensor adapter is configured to be disconnected from the connection head and from around the temperature sensor to expose a length of the temperature sensor for calibration while the spring remains compression loaded between the portion of the temperature sensor and the constraining member; and
wherein the elongate sensor adapter is configured to be reconnected to the connection head by sliding the elongate sensor adapter back over the temperature sensor.

15. The temperature sensor assembly of claim 14, wherein the portion of the temperature sensor comprises a spring seat having a resting surface that protrudes from a sensor wall of the temperature sensor to receive a force that the spring exerts in a first direction.

16. The temperature sensor assembly of claim 15, wherein the constraining member comprises a shoulder internally located in the connection head to receive a force that the spring exerts in a second opposing direction.

17. The temperature sensor assembly of claim 15, further comprising a connection head adapter coupled between the connection head and the sensor adapter.

18. The temperature sensor assembly of claim 17, wherein the constraining member comprises a shoulder internally located in the connection head adapter to receive a force that the spring exerts in a second opposing direction.

19. The temperature sensor assembly of claim 15, wherein the constraining member comprises a retention ring configured to retain a first end of the spring opposite a second end of the spring that engages with the spring seat.

20. The temperature sensor assembly of claim 19, wherein the elongate sensor adapter is removably coupled to the retention ring by a threaded joint.
